(19) United States
(12) Patent Application Publication
(10) Pub. No.: US 2020/0080003 A1
(43) Pub. Date: Mar. 12, 2020

(54) HIGH TEMPERATURE CARBONIZATION FURNACE

(71) Applicant: UHT UNITECH COMPANY LTD., TAOYUAN CITY (TW)

(72) Inventor: CHIH-YUNG WANG, TAOYUAN CITY (TW)

(21) Appl. No.: 16/541,299

(22) Filed: Aug. 15, 2019

(30) Foreign Application Priority Data
Sep. 6, 2018 (TW) 107131382

(51) Int. Cl. C10B 41/00; C10B 57/16; C10B 5/00; C10B 19/00; C10B 57/12; C10B 53/00; H05B 6/64; H05B 6/66; H05B 6/68; H05B 6/78; H05B 6/80

(52) U.S. Cl. CPC C10B 41/00; C10B 57/16; C10B 5/00; C10B 19/00; C10B 57/12; C10B 53/00; H05B 6/80; H05B 6/645; H05B 6/6473; H05B 6/664; H05B 6/681; H05B 6/78; H05B 6/6435

(57) ABSTRACT

A high temperature carbonization furnace has a cavity, at least two microwave units and a control unit. Each microwave unit is disposed along a processing path of the cavity. The control circuit receives signals of temperature sensors distributed on the processing path of the cavity. The control unit generates controls signals to control magnetrons of the different microwave units to be turned on/off, or to control powers of the magnetrons of the different microwave units, such that a location of the processing path, on which the microwave unit disposed, can attain an expected temperature condition. Further, the temperatures in the cavity can be adjusted precisely, such that the temperature distribution in the cavity is uniform, the uniformity for heating the processing object can be increased, and the temperature gradient of different temperature control regions can be controlled and adjusted, so as to achieve the advantage of adjusting and controlling the temperature condition of the processing path according to the requirement of the processing object.

### BACKGROUND

### 1. Technical Field

The present disclosure relates to a heat processing equipment, and in particular, to a high temperature carbonization furnace which can efficiently control and precisely adjust temperatures in the whole high temperature carbonization furnace, such that the temperature distribution in the cavity is uniform, the uniformity for heating the processing object can be increased, the temperature gradient of different temperature control regions can be controlled and adjusted, and even the temperature condition of the processing path can be segmentally adjusted according to the requirement of the processing object.

### 2. Description of Related Art

In industrial manufacturing field, the physic or chemical properties of a material can be changed by a heating process, the heating process can be seen as a serial processing method, and is the essential step of manufacturing processes of many products. For example, the carbon fiber is a novel carbon material containing more than 90% carbon content, which can be obtained by performing a serial heating process on an organic fiber.

In the continuous automatic manufacturing process of the carbon fiber, the fiber yarns are processed by the heating process with a predetermined speed, and thus the carbonization furnace must need an environment for efficiently processing the fiber yarns, and must further control the temperature condition of the processing path precisely, so as to achieve the expected carbonization effect of the fiber yarns which are processed by the heating process equipment.

The conventional continuous automatic manufacturing process of the carbon fiber usually utilizes a carbonization furnace of electro-thermal wires to perform a high temperature graphitization process or a graphitization process on the fiber yarns, but is has the disadvantages of slow heat conduction speed and hard heat preservation, and has the disadvantage that the sufficient temperature is attained by a long term heating since the temperature increasing speed is effected by the heat conduction effect. In particular, the temperature distribution of the whole electro-thermal wires is not uniform when working in practice, and there are obvious temperatures deviations at extension regions of the electro-thermal wires. Thus, it is hard to efficiently control the carbonization qualities of the fiber yarns, and the temperature condition of the processing path cannot be adjusted and controlled according the requirements of the processing objects. Further, though the conventional high temperature carbonization furnace utilizes the electro-thermal wires for heating, it cannot provides different temperatures of different regions in the cavity during the heating process since the electro-thermal wires are in shapes of long sheet structures, and it has the disadvantage that the temperature of the single one region in the cavity cannot be finely adjusted.

### SUMMARY

Accordingly, a main objective of the present disclosure is used to provide a high temperature carbonization furnace which can efficiently control and precisely adjust temperatures in the whole high temperature carbonization furnace, such that the temperature distribution in the cavity is uniform, the uniformity for heating the processing object can be increased, the temperature gradient of different temperature control regions can be controlled and adjusted, and even the temperature condition of the processing path can be segmentally adjusted according to the requirement of the processing object.

Another objective of the present disclosure is to provide a high temperature carbonization furnace which can adjust the power and on/off of each the magnetron, such that the different regions in the same cavity can provide different heating temperatures. That is, the working mode of each the magnetron in single region in the single cavity can be adjusted according to the signal of each the temperature sensor.

To achieve the above objective of the present disclosure, a high temperature carbonization furnace is provided and comprises a cavity, at least two microwave units and a control unit. The cavity has a processing path, and the cavity has a material inlet and a material outlet respectively disposed at two ends of the processing path. Each of the microwave units is disposed along the processing path of the cavity, and each of the microwave units has at least one magnetron. The control circuit is further configured to receive signals of temperature sensors which are distributed on the processing path of the cavity. The control circuit comprises at least one storage medium and a microprocessor electrically connected to each the storage medium, such that each the storage medium and the microprocessor read the signal of each the temperature sensor, and the control circuit generates a control signal to control a working mode of each the magnetron of each the microwave unit.

According to the above high temperature carbonization furnace, wherein according to the requirement of the processing object, the control circuit selects and sets the proper working mode of each the magnetron, and by turning on/off each the magnetron or adjusting the power of each the magnetron, the temperatures of the locations on which the microwave units of the processing path are located can attain the expected temperature conditions, such that an objective of segmentally adjusting and controlling the temperature conditions of the processing path based on the requirement of the processing object can be achieved.

According to the above structure, the high temperature carbonization furnace further has a gas supply unit connected to the cavity. The cavity has at least one gas inlet being communicated with the processing path, and the least one gas inlet is disposed at a front location of the processing path. The cavity has at least one gas outlet being communicated with the processing path, and the least one gas outlet is disposed at a back location of the processing path. The gas supply unit is connected to the at least one gas inlet.

According to the above structure, the high temperature carbonization furnace further has at least one heat preservation material disposed in the cavity.

According to the above structure, the high temperature carbonization furnace has a gas supply unit connected to the cavity. The cavity further has at least one heat preservation material disposed in the cavity. The cavity has at least one gas inlet being communicated with the processing path, and the least one gas inlet is disposed at a front location of the processing path. The cavity has at least one gas outlet being communicated with the processing path, and the least one gas outlet is disposed at a back location of the processing path. The gas supply unit is connected to the at least one gas inlet.

According to the above structure, each the microwave unit has the magnetrons disposed on two sides and a bottom location of the processing path.

According to the above structure, the high temperature carbonization furnace has the two microwave units disposed along the processing path of the cavity, and each the microwave unit has the three magnetrons.

According to the above structure, the high temperature carbonization furnace has the five microwave units disposed along the processing path of the cavity, and the five microwave units sequentially have the three, eight, ten, eight and three magnetrons.

According to the above structure, the high temperature carbonization furnace has the ten microwave units disposed along the processing path of the cavity, and the ten microwave units sequentially have the three, eight, eight, ten, ten, ten, eight, eight and three magnetrons.

The high temperature carbonization furnace provided by the present disclosure can immediately propagate the heat through the processing object, heat the processing object quickly, have a short reaction time and save the energy. Further, the processing path can be divided into several temperature control regions corresponding to the microwave units. By controlling the on/off of each the magnetron of each the microwave unit or the power of each the magnetron of each the microwave unit, the location of each of the microwave unit in the processing path can attain the expected temperature condition, such that the different heating requirements of the different processing objects can be meet. Moreover, by immediately control and adjust the power of each the magnetron of each the microwave unit, the processing path can keep the predetermined temperatures in different temperature control regions, so as to make sure the yielding rate and quality of the heat processing.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of architecture of a high temperature carbonization furnace provided by a first embodiment of the present disclosure.

FIG. 2 is a schematic diagram showing an allocation of the microwave units in the first embodiment of the present disclosure.

FIG. 3 is a curve diagram showing a temperature distribution of the high temperature carbonization furnace of the first embodiment in a first possible working mode.

FIG. 4 is a curve diagram showing a temperature distribution of the high temperature carbonization furnace of a second embodiment in a second possible working mode.

FIG. 5 is a schematic diagram of architecture of a high temperature carbonization furnace provided by the second embodiment of the present disclosure.

FIG. 6 is a schematic diagram of architecture of a high temperature carbonization furnace provided by a third embodiment of the present disclosure.

FIG. 7A is a schematic diagram showing an allocation of the microwave units in a fourth embodiment of the present disclosure.

FIG. 7B is a curve diagram showing a temperature distribution of the high temperature carbonization furnace of a fourth embodiment in a third possible working mode.

FIG. 8A is a schematic diagram showing an allocation of the microwave units in a fifth embodiment of the present disclosure.

FIG. 8B is a curve diagram showing a temperature distribution of the high temperature carbonization furnace of a fifth embodiment in a fourth possible working mode.

### DESCRIPTION OF THE EXEMPLARY EMBODIMENTS

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

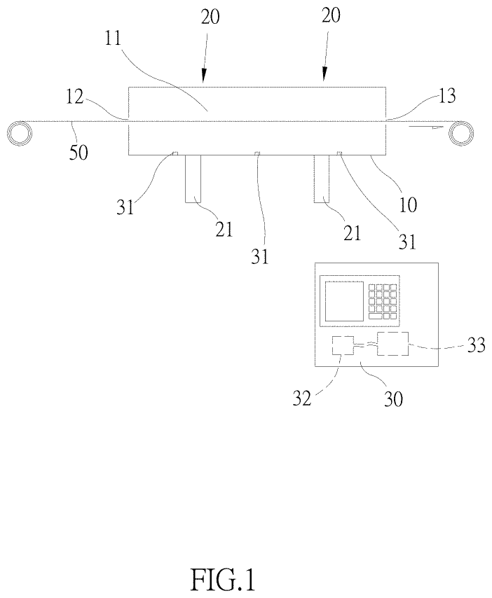

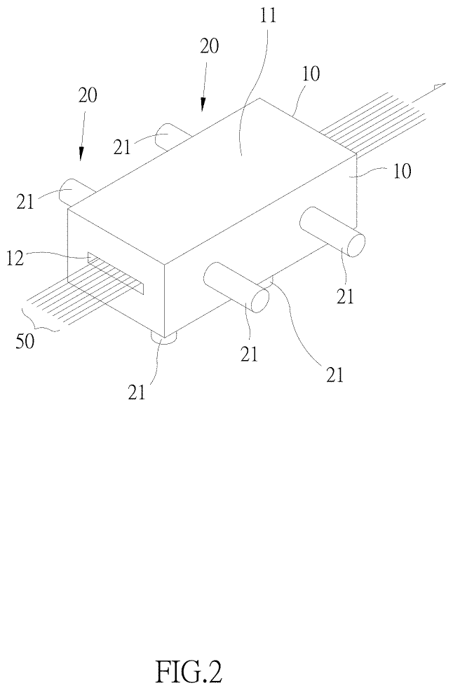

The present disclosure provides a high temperature carbonization furnace which can efficiently control and precisely adjust temperatures in the whole high temperature carbonization furnace, such that the temperature distribution in the cavity is uniform, the uniformity for heating the processing object can be increased, the temperature gradient of different temperature regions can be controlled and adjusted, and even the temperature conditions of the processing path can be segmentally adjusted according to the requirement of the processing object, wherein the processing object can be carbon fiber material, and there are many kinds of the carbon fiber material, for example, rayon, polyvinyl alcohol, vinylidene chloride, polyacrylonitrile (PAN) or pitch. As shown in FIG. 1 and FIG. 2, the high temperature carbonization furnace of the present disclosure mainly comprises a cavity 10, at least two microwave units 20 and a control circuit 30.

The cavity 10 has a processing path 11 which a processing object 50 (for example, the fiber yarns in the drawings) can pass, and the cavity 10 has a material inlet 12 and a material outlet 13 respectively disposed at two ends of the processing path 11.

Each of the microwave units 20 is disposed along the processing path 11 of the cavity 10, and each of the microwave units 20 has at least one magnetron 21. In the practical implementation, it is suggested that each the microwave unit 20 has the magnetrons 21 disposed on two sides and a bottom location of the processing path 11.

The control circuit 30 is further configured to receive signals of temperature sensors 31 which are distributed on the processing path 11 of the cavity 10. The control circuit 30 comprises at least one storage medium 32 and a microprocessor 33 electrically connected to each the storage medium 32, such that each the storage medium 32 and the microprocessor 33 read the signal of each the temperature sensor 31, and the control circuit 30 generates a control signal to control a working mode of each the magnetron 21 of each the microwave unit 20.

Accordingly, the control circuit 30 in the high temperature carbonization furnace of the present disclosure can select or set the proper working mode of each the magnetron 21 based upon the requirement of the processing object 50 (such as, the fiber yarns in the drawings), and under the operation of each the magnetron 21 of each the microwave unit 20, the focusing microwave can heat the continuously passing processing object 50 (such as, the fiber yarns in the drawings).

When the whole high temperature carbonization furnace operates, the control circuit 30 receives signals of the temperature sensors 31, and accordingly control the operations of the magnetrons 21 of the microwave units 20. Therefore, the high temperature carbonization furnace not only can efficiently control the hating temperature of the whole carbonization furnace, but also can immediately propagate the heat through the processing object, heat the processing object quickly, have a short reaction time and save the energy.

Even, the processing path 11 can be divided into several temperature control regions corresponding to the microwave units 20. By turning on/off each the magnetron 21 or adjusting the power of each the magnetron 21, the temperatures of the locations on which the microwave units 21 of the processing path are located can attain the expected temperature conditions, such that an objective of segmentally adjusting and controlling the temperature conditions of the processing path 11 based on the requirement of the processing object 50 can be achieved.

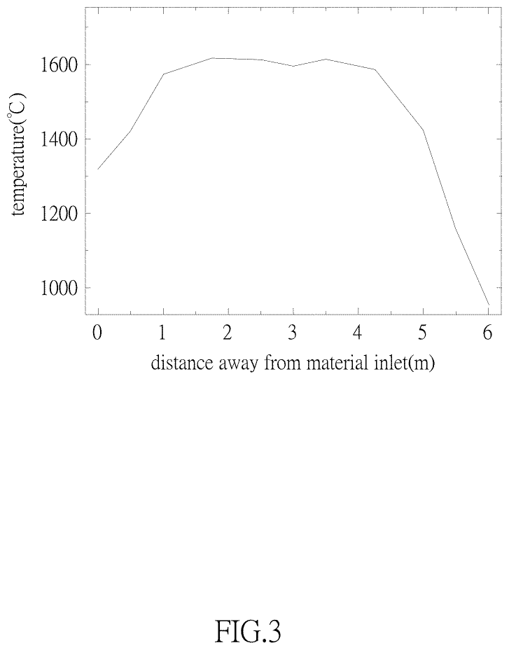

In the embodiment of FIG. 1 and FIG. 2, the two microwave units 20 of the whole high temperature carbonization furnace are disposed along the processing path 11 of the cavity 10, and each of the microwave units 20 has three magnetrons 21. When implementing, the temperature control regions of the processing path 11, corresponding to the two microwave units 20 are set to the same temperatures as shown in FIG. 3 (i.e. the two microwave units 20 are set to operate in the working modes of the same temperatures), such that the processing object 50 passing the processing path 11 can have the same heating effects.

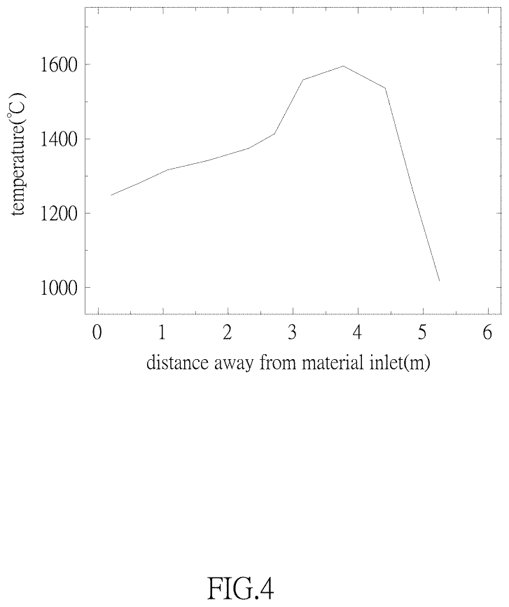

In the embodiment that the two microwave units 20 of the whole high temperature carbonization furnace are disposed along the processing path 11 of the cavity 10, and each of the microwave units 20 has three magnetrons 21, the temperature control region of the processing path 11, which the microwave unit 20 is adjacent to the material inlet 12, can be set to a be a lower temperature as shown in FIG. 4 (i.e. the microwave unit 20 adjacent to the material inlet 12 is set to operate in the working mode of the lower temperature), such the processing object 50 entering the cavity 10 is pre-heated, when the processing object 50 comes to the middle section of the processing path 11, the expected heating effect can be obtained, and before the processing object 50 has passed the cavity 10, the temperature of the processing object is gradually decreased.

Since the high temperature carbonization furnace provided by the present disclosure can turn on/off each the magnetron 21 of each the microwave unit 20 or adjusting the power of each the magnetron 21 of each the microwave unit 20, the effect of simply segmentally adjusting and controlling the temperature conditions of the processing path 11 can be achieved, and the heating process requirements of the different processing objects 50 can be meet. In particular, by immediately adjusting the power of each the magnetron 21 of each the microwave unit 20, the processing path 11 can keep the predetermined temperature condition, so as to make sure the heating processing yield rate and quality.

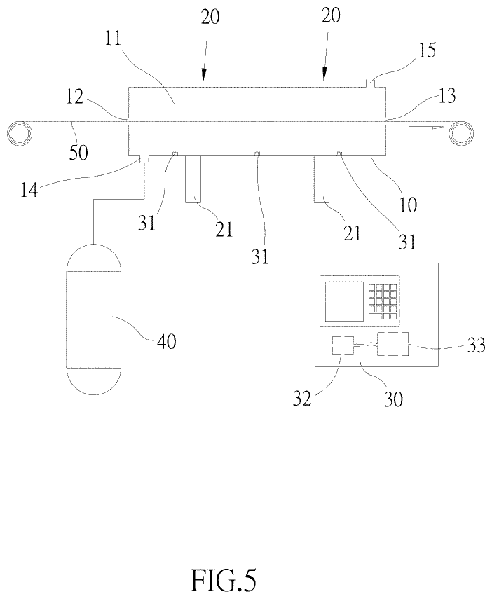

As shown in FIG. 5, when implementing, the high temperature carbonization furnace can further has a gas supply unit 40 connected to the cavity 10. The cavity 10 has at least one gas inlet 14 being communicated with the processing path 11, and the least one gas inlet 14 is disposed at a front location of the processing path 11. The cavity 10 has at least one gas outlet 15 being communicated with the processing path 11, and the least one gas outlet 15 is disposed at a back location of the processing path 11. The gas supply unit 40 is connected to the at least one gas inlet 14. When operating, the pre-stored gas of the gas supply unit 40 is simultaneously injected into the cavity 10, so as to activate the expected chemical reaction with the processing object 50.

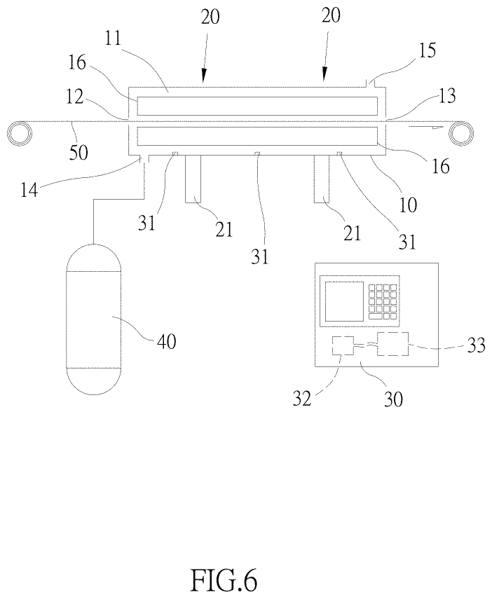

As shown in FIG. 6, when implementing the high temperature carbonization furnace of the present disclosure, the high temperature carbonization furnace further has at least one heat preservation material 16 disposed in the cavity 10. The heat preservation effect of the heat preservation material 16 can be utilized, such that the predetermined working temperatures in the cavity 10 can be maintained to save the energy.

Certainly, when implementing the high temperature carbonization furnace of the present disclosure, as shown in the drawings, it is suggested that, the high temperature carbonization furnace can have a gas supply unit 40 connected to the cavity 10; the cavity 10 further can have at least one heat preservation material 16 disposed in the cavity 10; the cavity 10 can have at least one gas inlet 14 being communicated with the processing path 11, and the least one gas inlet 14 can be disposed at a front location of the processing path 11; the cavity 10 can have at least one gas outlet 15 being communicated with the processing path 11, and the least one gas outlet 15 can be disposed at a back location of the processing path 11; and the gas supply unit 40 can be connected to the at least one gas inlet 14.

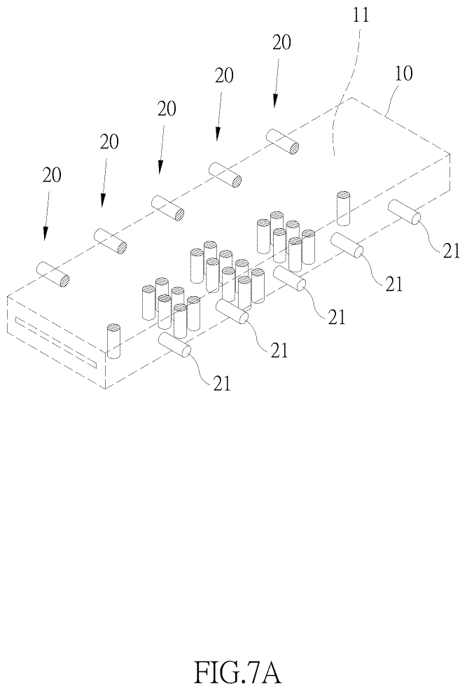

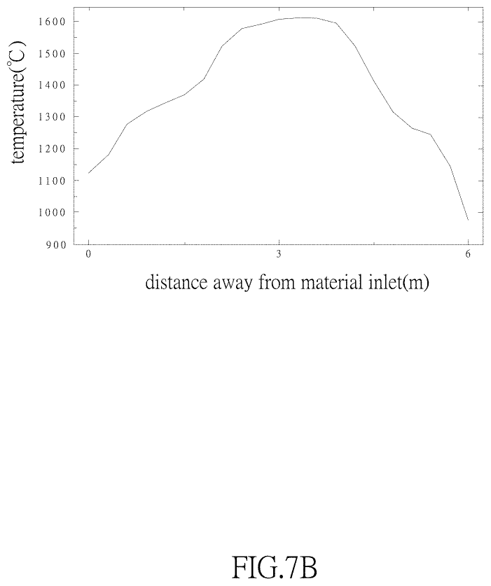

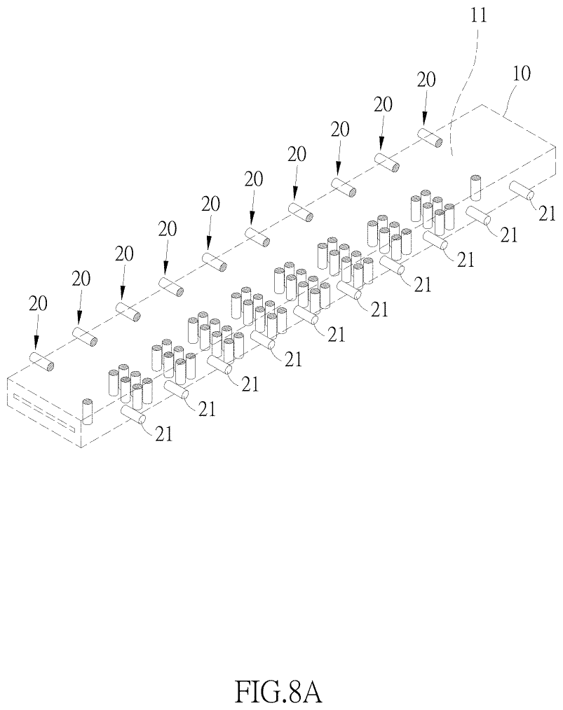

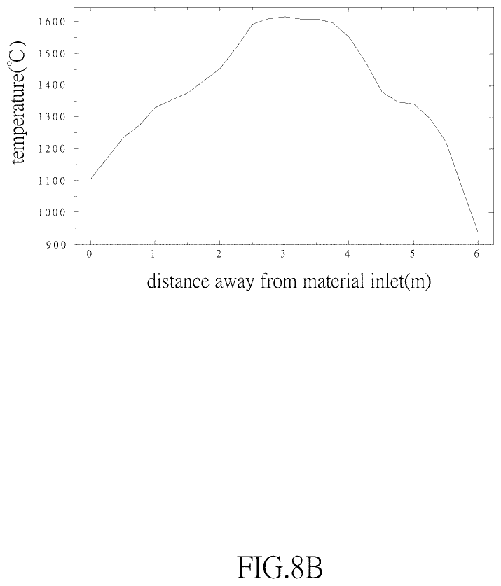

Further, regardless whether the high temperature carbonization furnace of the present disclosure further has the gas supply unit 40 connected to the cavity 10, or whether the cavity 10 has the heat preservation material 16 disposed in the cavity 10, the other high temperature carbonization furnaces can be seen as FIG. 7A and FIG. 8A, based upon the dimensions of the cavities 10, the numbers of the microwave units 20 distributed in the processing path 11 of the cavity 10 may be not identical. By dividing the processing path 11 to the different temperature control regions corresponding to the microwave units 20, and turning on/off each the magnetron 21 or adjusting the power of each the magnetron 21, the temperatures of the locations on which the microwave units 20 of the processing path 11 are located can attain the expected temperature conditions, such that an objective of segmentally adjusting and controlling the temperature conditions of the processing path 11 based on the requirement of the processing object 50 can be achieved. For example, in FIG. 7A, the high temperature carbonization furnace has five microwave units 20 disposed along the processing path 11 of the cavity 10, and in FIG. 7B, the temperature conditions of the temperature control regions of the processing path 11 of the cavity 10 can be seen by the temperature distribution (i.e. the working modes of the five microwave units 20 are set to achieve such temperature conditions). In FIG. 8A, the high temperature carbonization furnace has ten microwave units 20 disposed along the processing path 11 of the cavity 10, and in FIG. 8B, the temperature conditions of the temperature control regions of the processing path 11 of the cavity 10 can be seen by the temperature distribution (i.e. the working modes of the ten microwave units 20 are set to achieve such temperature conditions). By dividing the processing path 11 to the different temperature control regions corresponding to the microwave units 20, and turning on/off each the magnetron 21 or adjusting the power of each the magnetron 21, the temperatures of the different temperature control regions corresponding to the magnetrons 21 along the processing path 11 can be adjusted and controlled, such that an objective of segmentally adjusting and controlling the temperature conditions of the processing path 11 based on the requirement of the processing object 50 can be achieved.

In the embodiment of FIG. 7A, the high temperature carbonization furnace has the five microwave units 20 disposed along the processing path 11 of the cavity 10, and the five microwave units 20 sequentially have the three, eight, ten, eight and three magnetrons 21. Therefore, the processing path 11 can be sequentially divided into the temperature control regions corresponding to the five microwave units 20 which respectively have the three, eight, ten, eight and three magnetrons 21, the temperature condition of the location on which the microwave unit 20 of the processing path 11 is located can attain the expected temperature condition, and an objective of segmentally adjusting and controlling the temperature conditions of the processing path 11 based on the requirement of the processing object 50 can be achieved.

In the embodiment of FIG. 8A, the high temperature carbonization furnace has the ten microwave units 20 disposed along the processing path 11 of the cavity 10, and the ten microwave units 20 sequentially have the three, eight, eight, ten, ten, ten, ten, eight, eight and three magnetrons 21. Therefore, the processing path 11 can be sequentially divided into the temperature control regions corresponding to the five microwave units 20 which respectively have the three, eight, eight, ten, ten, ten, ten, eight, eight and three magnetrons 21, the temperature condition of the location on which the microwave unit 20 of the processing path 11 is located can attain the expected temperature condition, and an objective of segmentally adjusting and controlling the temperature conditions of the processing path 11 based on the requirement of the processing object 50 can be achieved.

Generally, when performing the heating process, the temperature control region adjacent to the material inlet 12, which the processing object 50 with the room temperature enters the cavity 10, should not be controlled at a higher temperature, since a buffer time should be reserved to the processing object 50. Therefore, the more the temperature control region is adjacent to the material inlet 12, the less the magnetrons 21 are allocated to the corresponding microwave unit 20 of the temperature control region.

When the processing object 50 has entered in the cavity 10, the higher temperature heating process should be performed, and thus it is suggested that, the microwave units 20 disposed at the middle section of the processing path 11 should be allocated with more magnetrons 21. Moreover, when the processing object 50 moves to the material outlet 13 from the middle section of the cavity 10, a buffer time which the processing object 50 contacts the air outer the cavity 10 should be reserved, and the temperature control region adjacent to the material outlet 13 cannot be controlled at a higher temperature. That is, the more the temperature control region is adjacent to the material outlet 13, the less the magnetrons 21 are allocated to the corresponding microwave unit 20 of the temperature control region.

Compared to the conventional structure, the high temperature carbonization furnace provided by the present disclosure can immediately propagate the heat through the processing object, heat the processing object quickly, have a short reaction time and save the energy. Further, the processing path can be divided into several temperature control regions corresponding to the microwave units. By controlling the on/off of each the magnetron of each the microwave unit or the power of each the magnetron of each the microwave unit, the location of each of the microwave unit in the processing path can attain the expected temperature condition, such that the different heating requirements of the different processing objects can be meet. Moreover, by immediately control and adjust the power of each the magnetron of each the microwave unit, the processing path can keep the predetermined temperatures in different temperature control regions, so as to make sure the yielding rate and quality of the heat processing.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A high temperature carbonization furnace, comprising: a cavity, at least two microwave units and a control circuit, wherein:
the cavity has a processing path, and the cavity has a material inlet and a material outlet respectively disposed at two ends of the processing path;
each of the microwave units is disposed along the processing path of the cavity, and each of the microwave units has at least one magnetron;
the control circuit is further configured to receive signals of temperature sensors which are distributed on the processing path of the cavity; and
the control circuit comprises at least one storage medium and a microprocessor electrically connected to each the storage medium, such that each the storage medium and the microprocessor read the signal of each the temperature sensor, and the control circuit generates a control signal to control a working mode of each the magnetron of each the microwave unit.

2. The high temperature carbonization furnace according to claim 1, wherein the high temperature carbonization furnace further has a gas supply unit connected to the cavity; the cavity has at least one gas inlet being communicated with the processing path, and the least one gas inlet is disposed at a front location of the processing path; the cavity has at least one gas outlet being communicated with the processing path, and the least one gas outlet is disposed at a back location of the processing path; and the gas supply unit is connected to the at least one gas inlet.

3. The high temperature carbonization furnace according to claim 1, wherein the high temperature carbonization furnace further has at least one heat preservation material disposed in the cavity.

4. The high temperature carbonization furnace according to claim 1, wherein the high temperature carbonization furnace has a gas supply unit connected to the cavity; the cavity further has at least one heat preservation material disposed in the cavity; the cavity has at least one gas inlet being communicated with the processing path, and the least one gas inlet is disposed at a front location of the processing path; the cavity has at least one gas outlet being communicated with the processing path, and the least one gas outlet is disposed at a back location of the processing path; and the gas supply unit is connected to the at least one gas inlet.

5. The high temperature carbonization furnace according to claim 1, wherein each the microwave unit has the magnetrons disposed on two sides and a bottom location of the processing path.

6. The high temperature carbonization furnace according to claim 1, wherein the high temperature carbonization furnace has the two microwave units disposed along the processing path of the cavity, and each the microwave unit has the three magnetrons.

7. The high temperature carbonization furnace according to claim 1, wherein the high temperature carbonization furnace has the five microwave units disposed along the processing path of the cavity, and the five microwave units sequentially have the three, eight, ten, eight and three magnetrons.

8. The high temperature carbonization furnace according to claim 1, wherein the high temperature carbonization furnace has the ten microwave units disposed along the processing path of the cavity, and the ten microwave units sequentially have the three, eight, eight, ten, ten, ten, eight, eight and three magnetrons.
